(19) United States
(12) Patent Application Publication
(10) Pub. No.: US 2018/0249155 A1
(43) Pub. Date: Aug. 30, 2018

(54) METHOD AND APPARATUS OF PREDICTION OFFSET DERIVED BASED ON NEIGHBOURING AREA IN VIDEO CODING

(71) Applicant: MEDIATEK INC., Hsin-chu (TW)

(72) Inventors: Chih-Wei HSU, Hsinchu City (TW); Ching-Yeh CHEN, Taipei City (TW); Han HUANG, Beijing (CN)

(21) Appl. No.: 15/755,200

(22) PCT Filed: Sep. 6, 2016
(86) PCT No.: PCT/CN2016/098183

§ 371 Date: Feb. 26, 2018

(30) Foreign Application Priority Data
Sep. 6, 2015 (CN) PCT/CN2015/088962

(51) Int. Cl. H04N 19/105; H04N 19/182

(52) U.S. Cl. CPC H04N 19/105; H04N 19/176; H04N 19/182

(57) ABSTRACT

A method and apparatus of video coding using Inter prediction with offset derived from neighbouring reconstructed pixels are disclosed. According to the present invention, the NRP (neighbouring reconstructed pixels) in one or more first neighbouring areas of a current block and the EMCP (extended motion-compensated predictors) in one or more second neighbouring areas of a motion-compensated reference block corresponding to the current block are determined. One or more prediction offsets between first pixel values of the NRP and second pixel values of the EMCP are determined. The current block is encoded or decoded using information including the prediction offset(s). The prediction offset may correspond to a single offset used for a whole block. Individual offsets may also be used the pixels of the current block.

### CROSS REFERENCE TO RELATED APPLICATIONS

The present invention claims priority to PCT Patent Application, Serial No. PCT/CN2015/088962, filed on Sep. 6, 2015. The PCT Patent Application is hereby incorporated by reference in its entirety.

### TECHNICAL FIELD

The present invention relates to video coding. In particular, the present invention relates to predicting offset between a current block and a reference block based on neighbouring pixels of the current block and the reference block to improve coding efficiency.

### BACKGROUND

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC and the emerging HEVC (High Efficiency Video Coding) standard.

FIG. 1 illustrates an exemplary adaptive Inter/Intra video coding system incorporating loop processing. For Inter-prediction, Motion Estimation (ME)/Motion Compensation (MC) 112 is used to provide prediction data based on video data from other picture or pictures. Switch 114 selects Intra Prediction 110 or Inter-prediction data and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data are stored in Reference Picture Buffer 134 and used for prediction of other frames. However, loop filter 130 (e.g. deblocking filter and/or sample adaptive offset, SAO) may be applied to the reconstructed video data before the video data are stored in the reference picture buffer.

FIG. 2 illustrates a system block diagram of a corresponding video decoder for the encoder system in FIG. 1. Since the encoder also contains a local decoder for reconstructing the video data, some decoder components are already used in the encoder except for the entropy decoder 210. Furthermore, only motion compensation 220 is required for the decoder side. The switch 146 selects Intra-prediction or Inter-prediction and the selected prediction data are supplied to reconstruction (REC) 128 to be combined with recovered residues. Besides performing entropy decoding on compressed residues, entropy decoding 210 is also responsible for entropy decoding of side information and provides the side information to respective blocks. For example, Intra mode information is provided to Intra-prediction 110, Inter mode information is provided to motion compensation 220, loop filter information is provided to loop filter 130 and residues are provided to inverse quantization 124. The residues are processed by IQ 124, IT 126 and subsequent reconstruction process to reconstruct the video data. Again, reconstructed video data from REC 128 undergo a series of processing including IQ 124 and IT 126 as shown in FIG. 2 and are subject to coding artefacts. The reconstructed video data are further processed by Loop filter 130.

In the High Efficiency Video Coding (HEVC) system, the fixed-size macroblock of H.264/AVC is replaced by a flexible block, named coding unit (CU). Pixels in the CU share the same coding parameters to improve coding efficiency. A CU may begin with a largest CU (LCU), which is also referred as coded tree unit (CTU) in HEVC. Each CU is a 2N×2N square block and can be recursively split into four smaller CUs until the predefined minimum size is reached. Once the splitting of CU hierarchical tree is done, each leaf CU is further split into one or more prediction units (PUs) according to prediction type and PU partition. Furthermore, the basic unit for transform coding is square size named Transform Unit (TU).

In HEVC, Intra and Inter predictions are applied to each block (i.e., PU). Intra prediction modes use the spatial neighbouring reconstructed pixels to generate the directional predictors. On the other hand, Inter prediction modes use the temporal reconstructed reference frames to generate motion compensated predictors. The prediction residuals are coded using transform, quantization and entropy coding. More accurate predictors will lead to smaller prediction residual, which in turn will lead to less compressed data (i.e., higher compression ratio).

Inter predictions will explore the correlations of pixels between frames and will be efficient if the scene are stationary or the motion is translational. In such case, motion estimation can easily find similar blocks with similar pixel values in the temporal neighbouring frames. For Inter prediction in HEVC, the Inter prediction can be uni-prediction or bi-prediction. For uni-prediction, a current block is predicted by one reference block in a previous coded picture. For bi-prediction, a current block is predicted by two reference blocks in two previous coded pictures. The prediction from two reference blocks is averaged to form a final predictor for bi-prediction.

Often the scenes may involve variation in lighting conditions. In this case, the pixel values between frames will be different even if the scene is stationary and the content is similar. It is desirable to develop a method that can predict the offset between a current block and a reference block.

### SUMMARY

A method and apparatus of video coding using Inter prediction with offset derived from neighbouring reconstructed pixels are disclosed. According to the present invention, the NRP (neighbouring reconstructed pixels) in one or more first neighbouring areas of a current block and the EMCP (extended motion-compensated predictors) in one or more second neighbouring areas of a motion-compensated reference block corresponding to the current block are determined. One or more prediction offsets between first pixel values of the NRP and second pixel values of the EMCP are determined. The current block is encoded into a video bitstream or decoded from the coded current block using information including said one or more prediction offsets.

The first neighbouring areas of the current block and the second neighbouring areas of the motion-compensated reference block have the same sizes and shapes. Each of the first neighbouring areas of the current block and each of the second neighbouring areas of the motion-compensated reference block consist of one or more selected pixels in previous reconstructed area of the current block and a corresponding area of the motion-compensated reference block respectively. For example, the first neighbouring areas of the current block consist of an above first neighbouring area above the current block and a left first neighbouring area to the left of the current block, and said one or more second neighbouring areas of the motion-compensated reference block consist of an above second neighbouring area above the motion-compensated reference block and a left second neighbouring area to the left of the motion-compensated reference block.

The average pixel values for the NPR and EMCP can be calculated using a subsampled pattern of the NPR and EMCP in order to reduce the required computations.

In one embodiment, the prediction offsets may correspond to a single offset, and the single offset is applied to whole current block. The single offset can be derived as a difference between an average first pixel value of the NRP and an average second pixel value of the EMCP.

In another embodiment, the prediction offsets may correspond to individual offsets, and the individual offsets are applied to individual pixels of the current block. The individual offsets for pixel locations in the NRP can be determined based on differences between the NRP and corresponding EMCP individually. Accordingly, the individual offsets for pixel locations in the current block can be derived from a weighted sum of individual offsets of neighbouring pixels, which are previously determined. The individual offsets for pixel locations in the current block can be derived sequentially according to a scanning order using a same configuration of the neighbouring pixels. The weighting factors for the weighted sum of individual offsets of neighbouring pixels can be determined depending of one or more coding parameters. For example, the individual offsets for pixel locations in the current block can be derived as an average offset of an above neighbouring pixel and a left neighbouring pixel. In one embodiment, the EMCP is within a neighbouring reference pixel area required to derive fractional-pel reference pixels for a fractional-pel motion vector.

The current block can be encoded or decoded using Inter prediction based on the motion-compensated reference block and said one or more prediction offsets. The motion-compensated reference block can be determined based on block location of the current block and an associated motion vector.

A flag can be signalled explicitly or determined implicitly to indicate whether said one or more prediction offsets are used for said encoding or decoding the current block. The flag can be determined implicitly based on statistics of neighbouring pixels or blocks of the current block.

When a single offset pixel value is used for a whole block, a directional mode may be used, which adaptively use the above neighbouring areas or the left neighbouring areas to derive the single offset pixel value. In one example, the above neighbouring areas or the left neighbouring areas are adaptively selected according to a direction of a spatial merge candidate. In another embodiment, a forced mode may be used, which forces the offset pixel value to be a non-zero value if the offset pixel value is zero.

Whether the prediction offsets are used for encoding or decoding the current block may depend on one or more coding parameters. For example, whether said one or more prediction offsets are used for said encoding or decoding the current block depends on PU (prediction unit) size, CU (coding unit) size or both.

### BRIEF DESCRIPTION OF DRAWINGS

FIG. 1 illustrates an exemplary Inter/Intra video encoding system using transform, quantization and loop processing.

FIG. 2 illustrates an exemplary Inter/Intra video decoding system using transform, quantization and loop processing.

FIG. 3 illustrates an example of offset derivation according to one embodiment of the present invention, where N above neighbouring lines and N left neighbouring lines are used to derive one or more prediction offset.

FIG. 4 illustrates an example of deriving individual offsets for a current block, where the individual offsets of the neighbouring reconstructed pixels are derived first and the individual offsets for the current block are derived by averaging the individual offsets of the above neighbouring pixel and the left neighbouring pixel.

FIG. 5 illustrates an exemplary flowchart for a video coding system utilizing one or more Inter prediction offsets derived from neighbouring reconstructed pixels of the current block and corresponding area of a reference block according to an embodiment of the present invention.

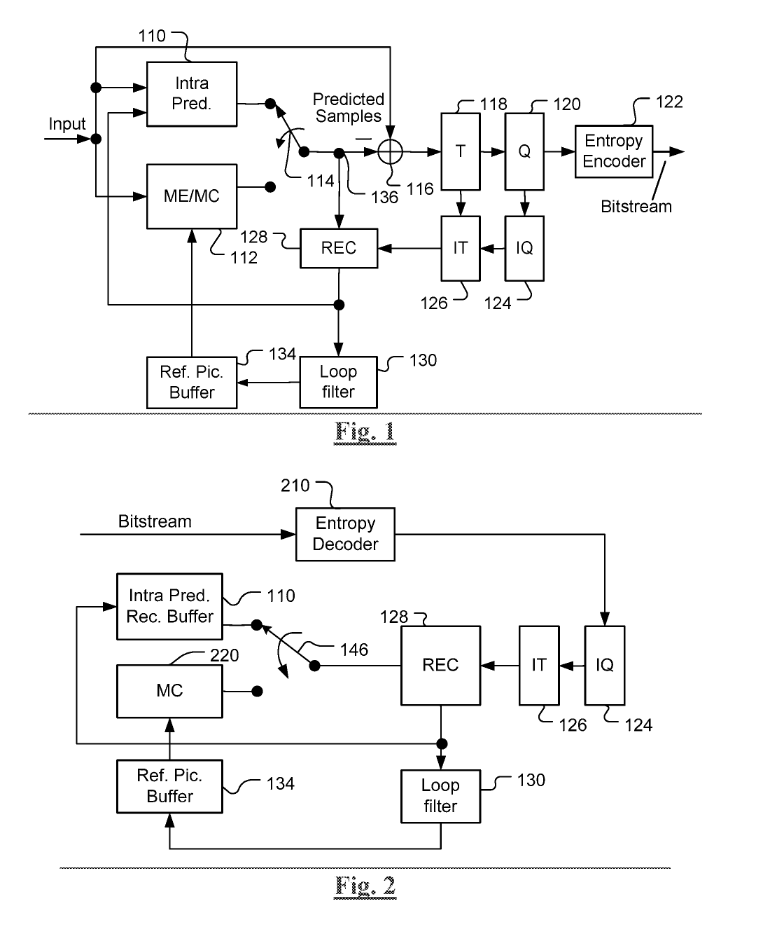

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, the conventional Inter prediction is rather static and cannot adapt to local characteristics in the underlying video. In particular, the conventional Inter prediction does not properly handle the offset between a current block and a reference block. Accordingly, in one embodiment of the present invention, a prediction offset is added to improve the accuracy of motion compensated predictors. With this offset, the different lighting conditions between frames can be handled.

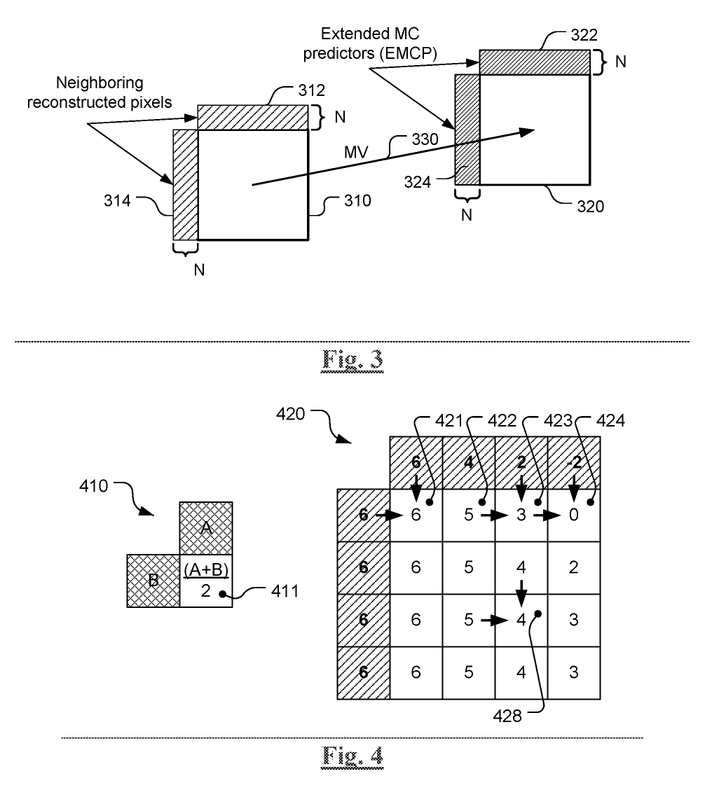

In one embodiment, the offset is derived using neighbouring reconstructed pixels (NRP) and extended motion compensated predictors (EMCP). FIG. 3 illustrates an example of offset derivation according to one embodiment of the present invention. In FIG. 3, the neighbouring reconstructed pixels (NRP) comprise N above neighbouring lines 312 above the current block 310 and N left neighbouring lines (i.e., vertical lines) 314 to the left of the current block 310. The extended motion compensated predictors (EMCP) comprise N above neighbouring lines 322 above the motion-compensated reference block 320 and N left neighbouring lines (i.e., vertical lines) 324 to the left of the motion-compensated reference block 320. The motion-compensated reference block 320 is identified according to the location of the current block 310 and the motion vector (MV) 330.

In the above example, the patterns chosen for NRP and EMCP are N left neighbouring lines and N above neighbouring lines of the current PU, where N is a predetermined value. However, the patterns of neighbouring areas can be of any size and shape, which can be determined according to encoding parameters, such as PU or CU sizes, as long as they are the same for both NRP an EMCP. While the patterns of neighbouring areas can be of any size and shape, the patterns of neighbouring areas should be within the area of previously reconstructed pixels of the current block.

For motion compensation with motion vectors with fractional-pel accuracy, neighbouring reference pixels outside the corresponding reference block will be needed to derive reference pixels at fractional-pel locations. In this case, the neighbouring reference pixels outside the corresponding reference block for calculating neighbouring reference pixels at fractional-pel locations can be used as the EMCP pixels.

The offset can be calculated as the average pixel value of NRP minus the average pixel value of EMCP. In other words, the offset value (Offset) can be derived as:

Offset=Average of NPR−Average of EMCP (1)

The derived offset will be specific for each PU and applied to the whole PU along with the motion compensated predictors. In other words, the modified predictors according to this embodiment are generated by adding the offset to the motion compensated predictors. This offset derivation method is referred as the Neighbouring-derived Prediction Offset (NPO). In one embodiment, the NPO is only applied to blocks coded in the skip mode or 2N×2N merge mode. The merge mode is a technique for MVP (motion vector prediction), where the motion vector for a block may be predicted using MVP. A merge candidate list may be used for coding a block in a merge mode. When the merge mode is used to code a block, the motion information (e.g. motion vector) of the block can be represented by one of the candidates MV in the merge MV list. When a block is coded in a merge mode, the motion information is “merged” with that of a neighbouring block by signalling a merge index instead of explicitly transmitted. However, the prediction residuals are still transmitted. In the case that the prediction residuals are zero or very small, the prediction residuals are “skipped” (i.e., the skip mode) and the block is coded by the skip mode with a merge index to identify the merge MV in the merge list.

As shown in eq. (1), the average value is calculated based on the pixels in NPR and pixels in EMCP, which may involve lot of operations. In order to reduce the required operations to derive the average values of pixels in NPR and pixels in EMCP, the average values can be computed based on subsampled pixels in NPR and EMCP according to one embodiment of the present invention. For example, one pixel (e.g. the upper left pixel) of each 2×2 pixels can be used to calculate the average values of pixels in NPR and EMCP. Any subsampling pattern may be used as long as the same subsampling pattern is used for both NPR and EMCP.

In another embodiment, individual offset for each pixel of the current PU are used instead of a single offset for the whole PU. According to this embodiment, the offset for pixels in the NRP (i.e., 312 and 314) are generated individually as each pixel in the NRP minus each corresponding pixel in the EMCP (i.e., 322 and). After individual offsets in the neighbouring areas are calculated, the individual offset for each position in the current PU can be derived based on the individual offsets in the neighbouring areas. For example, the individual offset for each position in the current PU can be derived as the average offsets of the left and above pixels, where the individual offsets have been already derived. This offset derivation method is referred as the Pixel-Based or Pixel-Adaptive Neighbouring-derived Prediction Offset (PA-NPO).

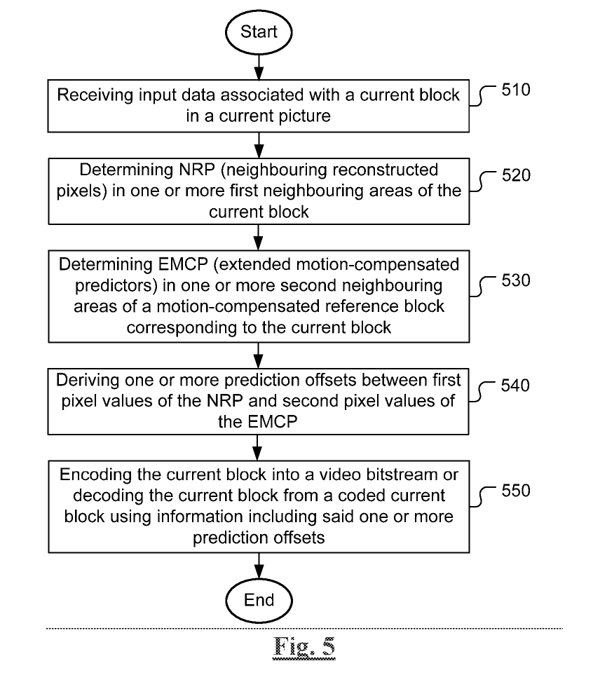

An example of individual offset derivation is shown in FIG. 4, where the individual offsets in the above neighbouring positions are 6, 4, 2 and −2 and the individual offsets in the left neighbouring positions are 6, 6, 6 and 6. For each position of the current PU, the individual offset at a current position 411 is calculated as the average of the above offset and the left offset (i.e., positions with offsets A and B) as shown in illustration 410. The derived individual offsets are shown in illustration 420. For the first position 421 in the top left corner, the individual offset of 6 is generated by averaging the offset from left (i.e., 6) and above (i.e., 6). For the next position 422, the offset is equal to (6+4)/2=5. The individual offsets for the next two positions (423 and 424) can be derived accordingly as 3 and 0 respectively. In order to ensure that the neighbouring individual offsets are already derived, the derivation of individual offsets for the current bock (e.g. PU) can be performed according to a raster scanning order sequentially. For example, the individual offset for the position 428 can be derived as 4 since the neighbouring individual offsets are already obtained (i.e., 5 and 4). Since the neighbouring pixels are more highly correlated with the boundary pixels, so do the offsets. This method can adapt the offset according to the pixel positions. The derived offsets can be adapted over the PU and applied to each PU position individually along with the motion compensated predictors.

The individual offset for each pixel in the current block can be calculated as a weighted average of the left and above offsets. The weightings can be predetermined values or can depend on coding parameters.

The neighbouring derived prediction offset method as disclosed above can be always applied in a coding system. The neighbouring derived prediction offset method can also be turned on or off explicitly. For example, a flag can be signalled explicitly or derived or implicitly, such as based on the statistics of its neighbours. Whether to apply the neighbouring derived prediction offset method can be according to the CU size, PU size or other coding parameters.

The present invention also addresses syntax design for signalling the offset method. For example, a syntax element can be signalled using variable length code, which may be context coded. If the code corresponds to “0”, it indicates no offset is used. If the code corresponds to “10”, it indicates NPO being used. If the code corresponds to “11”, it indicates PA-NPO being used.

When the NPO is selected, one embodiment of the present invention uses “forced NPO” if the offset derived is zero. When the code corresponds to “0”, it indicates no offset is used. Therefore, no offset mode and the NPO mode with zero offset imply the same case. In order not to waste the offset value in the NPO mode, the “forced NPO” mode uses a non-zero offset value. For example, the offset value is forced to “+1” if the offset value is zero.

When the NPO is selected, one embodiment of the present invention uses “directional NPO”, where offset is derived from the left or above boundaries according to directions of spatial merge candidates. For example, if the current block is coded in the merge mode, the patterns of neighbouring areas may correspond to the left areas if the current block is “merged” with the left block, and the patterns of neighbouring areas may correspond to the above areas if the current block is “merged” with the above block. Other criterion may also be used to select the “direction” of the patterns of neighbouring areas.

In another embodiment, when the PA-NPO is selected, the weightings of 5/3 or 3/5 can be applied, according to directions of spatial merge candidates, for deriving the weighted average of the left and above offsets instead of using the weightings of 1/1.

FIG. 5 illustrates an exemplary flowchart for a video coding system utilizing one or more Inter prediction offsets derived from neighbouring reconstructed pixels of the current block and corresponding area of a reference block according to an embodiment of the present invention. According to this embodiment, input data associated with a current block in a current picture is received in step 510. The NRP (neighbouring reconstructed pixels) in one or more first neighbouring areas of the current block are determined in step 520. The EMCP (extended motion-compensated predictors) in one or more second neighbouring areas of a motion-compensated reference block corresponding to the current block are also determined in step 530. One or more prediction offsets between first pixel values of the NRP and second pixel values of the EMCP are derived in step 540. The current block are encoded into a video bitstream or decoded from a coded current block using information including said one or more prediction offsets in step 550.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of Inter prediction for video coding using adaptive offset, the method comprising:
receiving input data associated with a current block in a current picture;
determining NRP (neighbouring reconstructed pixels) in one or more first neighbouring areas of the current block;
determining EMCP (extended motion-compensated predictors) in one or more second neighbouring areas of a motion-compensated reference block corresponding to the current block;
deriving one or more prediction offsets between first pixel values of the NRP and second pixel values of the EMCP; and
encoding the current block into a video bitstream or decoding the current block from a coded current block using information including said one or more prediction offsets.

2. The method of claim 1, wherein said one or more first neighbouring areas of the current block and said one or more second neighbouring areas of the motion-compensated reference block have same sizes and shapes.

3. The method of claim 2, wherein each of said one or more first neighbouring areas of the current block and each of said one or more second neighbouring areas of the motion-compensated reference block consist of one or more selected pixels in previous reconstructed area of the current block and a corresponding area of the motion-compensated reference block respectively.

4. The method of claim 2, wherein said one or more first neighbouring areas of the current block consist of an above first neighbouring area above the current block and a left first neighbouring area to the left of the current block, and said one or more second neighbouring areas of the motion-compensated reference block consist of an above second neighbouring area above the motion-compensated reference block and a left second neighbouring area to the left of the motion-compensated reference block.

5. The method of claim 4, wherein said one or more prediction offsets correspond to a single offset, and the single offset is applied to the whole current block.

6. The method of claim 1, wherein said one or more first neighbouring areas of the current block and said one or more second neighbouring areas of the motion-compensated reference block are subsampled using a same subsampling pattern to reduce computations required to calculate average pixel values of the NPR and the EMCP.

7. The method of claim 1, wherein the EMCP is within a neighbouring reference pixel area required to derive fractional-pel reference pixels for a fractional-pel motion vector.

8. The method of claim 1, wherein said one or more prediction offsets correspond to a single offset, and the single offset is applied to the whole current block.

9. The method of claim 8, wherein the single offset is derived as a difference between an average first pixel value of the NRP and an average second pixel value of the EMCP.

10. The method of claim 9, wherein said one or more first neighbouring areas of the current block consist of an above first neighbouring area above the current block and a left first neighbouring area to the left of the current block, and said one or more second neighbouring areas of the motion-compensated reference block consist of an above second neighbouring area above the motion-compensated reference block and a left second neighbouring area to the left of the motion-compensated reference block, and wherein either the above first neighbouring area and the above second neighbouring area or the left first neighbouring area and the left second neighbouring area are adaptively selected to determine the average first pixel value of the NRP and the average second pixel value of the EMCP.

11. (canceled)

12. The method of claim 9, wherein if the single offset is zero, the single offset is forced to have a non-zero value.

13. The method of claim 1, wherein said one or more prediction offsets correspond to individual offsets, and the individual offsets are applied to individual pixels of the current block.

14. The method of claim 13, wherein the individual offsets for pixel locations in the NRP are determined based on differences between the NRP and corresponding EMCP individually, and the individual offsets for pixel locations in the current block are derived from a weighted sum of individual offsets of neighbouring pixels, and wherein the individual offsets of neighbouring pixels are previously determined.

15. (canceled)

16. (canceled)

17. (canceled)

18. The method of claim 1, wherein the current block is encoded or decoded using Inter prediction based on the motion-compensated reference block and said one or more prediction offsets.

19. The method of claim 18, wherein the motion-compensated reference block is determined based on block location of the current block and an associated motion vector.

20. The method of claim 1, wherein a flag is signalled explicitly or determined implicitly to indicate whether said one or more prediction offsets are used for said encoding or decoding the current block.

21. The method of claim 20, wherein the flag is determined implicitly based on statistics of neighbouring pixels or blocks of the current block.

22. The method of claim 1, wherein whether said one or more prediction offsets are used for said encoding or decoding the current block depends on one or more coding parameters.

23. The method of claim 22, wherein whether said one or more prediction offsets are used for said encoding or decoding the current block depends on PU (prediction unit) size, CU (coding unit) size or both.

24. An apparatus for Inter prediction in video coding, the apparatus comprising one or more electronic circuits or processors arranged to:
receive input data associated with a current block in a current picture;
determine NRP (neighbouring reconstructed pixels) in one or more first neighbouring areas of the current block;
determine EMCP (extended motion-compensated predictors) in one or more second neighbouring areas of a motion-compensated reference block corresponding to the current block;
derive one or more prediction offsets between first pixel values of the NRP and second pixel values of the EMCP; and
encode or decode the current block using information including said one or more prediction offsets.
